(19) United States
(12) Patent Application Publication
(10) Pub. No.: US 2008/0263535 A1
(43) Pub. Date: Oct. 23, 2008

(54) METHOD AND APPARATUS FOR DYNAMIC APPLICATION UPGRADE IN CLUSTER AND GRID SYSTEMS FOR SUPPORTING SERVICE LEVEL AGREEMENTS

(75) Inventors: Daniel Manuel Dias, Mohegan Lake, NY (US); GRAEME NEVILLE DIXON, CARMEL, NY (US); DAVID CARL FRANK, OSSINING, NY (US); AJAY MOHINDRA, YORKTOWN HEIGHTS, NY (US); LUIS JAVIER OSTDIEK, SAN JOSE, CA (US); CHRISTOPHER P. VIGNOLA, PORT JERVIS, NY (US)

Correspondence Address: GEORGE A. WILLINGHAN, III;AUGUST LAW GROUP, LLC, P.O. BOX 19080, BALTIMORE, MD, 21284-9080, US

(73) Assignee: INTERNATIONAL BUSINESS MACHINES CORPORATION, ARMONK, NY (US)

(21) Appl. No.: 12/166,927

(22) Filed: Jul. 2, 2008

Related U.S. Application Data
(63) Continuation of application No. 11/128,618, filed on May 13, 2005.
(60) Provisional application No. 60/636,124, filed on Dec. 15, 2004.

(51) Int. Cl. G06F 9/44

(52) U.S. Cl. 717/168

(57) ABSTRACT

Methods and systems are provided for conducting maintenance such as software upgrades in components and nodes within a computer network while maintaining the functionality of the computer network in accordance with prescribed performance parameters. A balance is achieved between the rate of performing a desired system upgrade and the necessary performance parameters by empirically determining anticipated system loads and selecting the maximum number of components that can be upgraded simultaneously while meeting the anticipated loads. Provisions are made for the staggering of components through the upgrade process and for the return of components to active service in the computer network in response to unanticipated load spikes. Validation of successful upgrades is also provided.

### CROSS-REFERENCE TO RELATED APPLICATIONS

The present application is a continuation of co-pending U.S. application Ser. No. 11/128,618, filed May 13, 2005, which, pursuant to 35 U.S.C. § 119(e), claimed priority to provisional application No. 60/636,124 filed Dec. 15, 2004. The entire disclosures of those applications are incorporated herein by reference.

### FIELD OF THE INVENTION

The present invention relates to software and applications management in networked computer environments.

### BACKGROUND OF THE INVENTION

Computer systems, including personal computers and network servers, require regular maintenance to ensure proper operation and up-to-date protection, for example from computer viruses. This regular maintenance includes the installation of software fixes or patches and upgrades to the operating system, applications, firewalls and virus checking programs running on the computer system. Performance of the desired maintenance, however, consumes processor and memory resources of the computer system being maintained, limiting the resources available to execute other applications on the computer system concurrent with the maintenance functions. In fact, maintenance functions can require such a significant amount of computer resources that no other applications or functions can be executed during a maintenance function. As the number, frequency and complexity of these maintenance functions increases, the interruption of other system functionalities also increases.

The costs associated with performing computer maintenance functions are multiplied in clustered computer systems. Clustered computer systems are arrangements or groupings of individual computer systems that are typically networked together to support high volume applications that could not be handled by a single computer system. An example of a high volume application is a high volume Web site. Clustered computer systems can be arranged as a network of distributed, self-contained computer systems or processors, i.e. personal computers, or as one or more client/server groupings. A client/server grouping contains a server computer networked to a plurality of client computers. The server computer provides resources to each one of the client computers including file storage, provision of application licenses and execution of server-based applications. Clustered computer systems typically use multiple servers to provide essential functions to multiple clients in multiple concurrent user sessions. The use of multiple servers improves server availability and system capacity.

In addition to clients, servers and self-contained computers, clustered computer systems also contain routers, switches, hubs, storage mediums, data servers and system management servers. The routers, switches and hubs distribute client requests among the multiple application servers. The system management server is in communication with a router and each of the application servers and stores a mapping of applications and software programs to application servers on which they are contained. This mapping information is accessed by the router to complete routing functions. The system management server provides configuration and health/load information to the router of the communications network.

These various components within the clustered computer system are referred to as nodes, and many of the nodes contain software programs that provide for the operation of the node or that perform applications that are provided by the clustered computer system. Typically, an identical or nearly identical software program is utilized simultaneously by more than one node. Therefore, in these clustered computer systems, upgrades, fixes and other maintenance functions need to be applied simultaneously to more than one node and may even need to be applied to all nodes within the clustered computer system. In general, as the number of nodes within the clustered computer system requiring simultaneous maintenance increases, the drain on available resources also increases. This drain on resources inhibits the performance of the clustered computer system.

Continuous, uninterrupted service is the desired goal in clustered computer systems. For example, high volume applications typically operate under a set of prescribed service goals, such as response time and system throughput, that are expressed in service level agreements (SLA's) or service level objectives (SLO's). These SLA's and SLO's need to be consistently met by the clustered computer system providing the high volume application, including during maintenance procedures. Failure to meet the prescribed performance parameters can result in a shut-down of the entire clustered computer system. Failure to meet the SLA's and SLO's can also trigger other penalties including refunds to customers or the loss of customers. Although excess capacity can be provided in a clustered computer system to compensate for the loss of nodes during maintenance, this is not a cost effective solution from a business perspective.

One solution is to perform each maintenance function sequentially one node at a time. For example, a single node from among the plurality of nodes requiring the desired maintenance is identified and removed from active service in the clustered computer system. Once removed, maintenance is performed on the single node without disrupting any pending client requests. Once the desired maintenance is completed, new client requests are routed to the node, and a second node from among the plurality of nodes requiring the desired maintenance is identified, removed and updated. This process is repeated until all of the nodes requiring the desired maintenance are updated. However, this process is relatively time consuming, especially for clustered systems containing a large number of nodes that need to be maintained. In addition, all of the resources associated with a selected node are removed from the clustered computer system in order to maintain or to update what may constitute only a small fraction of the node's total capacity or stored software applications. Accordingly, the distributed computer system's burden is increased during a software upgrade process because the system must service client's requests with one fewer application server.

A method for upgrading applications without bringing down an entire node within the clustered computer system is disclosed in U.S. patent application Ser. No. 09/675,790. Instead of performing maintenance functions on entire nodes, only the systems or software contained on the node that are the object of the maintenance function are removed from the active clustered computer system. For example, the node on which the software being upgraded resides can continue servicing requests for other pieces of software, reducing the burden on the distributed computing system during maintenance.

However, this method requires the addition of a system and method for selectively redirecting only client sessions for the systems or software that are the subject of the maintenance functions, which is achieved by modifying software at the server level to track servers capable of handling requests on the basis of each individual piece of software and to track requests on the basis of each individual piece of software. This results in increased cost and increased complexity. In addition, the system still only performs the desired maintenance one server at a time. Moreover, the node is still effectively completely removed from the system for the purposes of the system or software that is the subject of the maintenance function.

Therefore, a need still exists for methods and systems for performing maintenance functions on the nodes in clustered computer systems that reduces the time necessary to perform the maintenance function on all affected nodes and continuously maintains the desired performance parameters in the clustered computer system.

### SUMMARY OF THE INVENTION

The present invention is directed to systems and methods that maintain the necessary performance and service levels as expressed in service level agreements (SLA's) and service level objectives (SLO's) during system maintenance and upgrades.

Methods in accordance with exemplary embodiments of the present invention quiesce a subset of the nodes or components within a computer network system, upgrade that subset, test the subset, cascade the upgrades across all the nodes within the system upon validation and support the necessary performance parameters in the system such as the service level objectives (SLO's) for the system. A SLO can be expressed in terms of the maximum throughput or the response time that is to be supported by the system. The time taken for a given upgrade depends on the number of nodes upgraded simultaneously; however, increasing the number of nodes upgraded simultaneously reduces available system capacity during the upgrade. Therefore, the rate of upgrade is adjusted based on current and predicted system loads and actual loads during the upgrade process, achieving the minimum possible time for the upgrade to finish while supporting the desired performance parameters.

Methods in accordance with exemplary embodiments of the present invention can be used in any networked computer environment, for example high volume Web site environments configured as multi-tier systems and having a routing/dispatching tier, a Web Server and Web Application Server (WAS) tier, and a database (DB) tier. Suitable methods are used to update nodes in any one of these tiers. Regardless of the tier selected, the update is applied to all affected nodes within that tier.

In order to achieve the desired balance between the rate of providing the desired upgrade and the provision of the prescribed performance parameters, the load in the computer system is monitored and analyzed to determine a time when the load on the system is predicted to be low enough, or is predicted to continue to be low enough, such that the performance parameters can be achieved even with one or more nodes removed from the active cluster of nodes within the system. A determination is also made regarding the number of nodes that can be removed from the active cluster of nodes during this period of time. Once a suitable time is determined, a subset of the nodes, of the previously determined size, is selected to receive the necessary upgrade.

In order to remove the selected nodes from the active cluster of nodes, components, for example routers, that forward system requests to these nodes are reconfigured to stop routing new requests to a selected subset of nodes. Although no new requests are being forwarded to the nodes in the selected subset, one or more of these nodes may already be processing existing requests. Therefore, the selected nodes are monitored to determine when all of the pending requests have been completed, i.e. when the nodes have quiesced. In order to prevent the period of time for completing pending requests from extending indefinitely, ongoing requests in each selected node are discarded if that selected node fails to quiesce within a pre-specified maximum time period.

After the selected nodes have quiesced, the desired upgrade or maintenance is performed in the nodes using appropriate procedures for performing the maintenance or system upgrade. The upgrades are then tested or validated. Initially, one or more routers are reconfigured to route a small test fraction of the load to the selected nodes. If the selected nodes fail on the test load, the system operator is so informed and the upgrade is removed from the selected nodes, i.e. the nodes are returned to a pre-upgrade state. The selected nodes are then returned to the active cluster, and the upgrade process is halted. In addition to, or as an alternative, the selected nodes are validated with a full stress load. For example, if the test load is successful, the router is configured to send a stress load to the selected nodes. As with the test load, if the selected nodes fail the stress test, the upgrade process is reversed, and the selected nodes are returned to the active cluster.

If the upgrade is successfully validated, the process of subset selection and upgrading is repeated until all nodes within the system requiring the upgrade have been upgraded. For example, following the upgrade of the first selected subset, the load on the system is monitored again and a determination is made about the number of nodes that can be selected for a second subset. In addition, a time frame for the removal of this second set from the active cluster is determined. Having determined that the desired performance parameters can be met without this second subset of nodes, this new subset is selected for upgrade. The upgrade process is repeated for the new subset of selected nodes. At the completion of each upgrade of each selected subset of nodes, the subsequent set of nodes is selected based on the current, and optionally the predicted, load in the system.

Since unexpected load spikes can occur during an upgrade, the load in the system is monitored during the upgrade process, and if the load grows or is predicted to grow above the load that can be supported by the active nodes, one or more nodes that are being upgraded and that have not yet been quiesced are chosen to be quickly re-included in the active cluster of nodes without the upgrade being performed. This takes advantage of the fact that most of the time required for a given upgrade involves the time to quiesce a node and that the time to upgrade the application itself is comparatively small. Once the nodes are chosen to be re-included in the active cluster, routers within the system are reconfigured to include these nodes back in the router's active node list.

If the time for performing an upgrade, though smaller than the quiescing time, is longer than the time desired for responding to a spike by quickly re-including nodes, then the selected nodes are passed through the upgrade process in a staggered ordered. For example, the state of nodes in the upgrade process is either that of being quiesced, quiesced but waiting for installation of the upgrade, upgrade being installed or re-integrating the node following installation. The number of nodes in the state of having the update installed is limited to a number less than the total number selected for upgrade. Limiting the number of nodes being actively updated at any one time is achieved by staggering the start time of the quiescing process, so that nodes enter the state of waiting for the installation of the upgrade in a staggered manner. In addition, passage of a node from the waiting state to the active upgrading state can be controlled through the use of mechanism such as requiring a ticket to enter the state of upgrade installation. Nodes in any state other than the state of the upgrade being installed can be re-integrated into the active cluster very quickly.

Since the number of nodes selected to be upgraded at any time is limited based on the current and predicted loads in the system, a load prediction model is used that obtains data on both the past history of the load and the current load and that uses these data to project the expected short term load out to approximately the average time to upgrade a node. This projected load is used in a capacity planner to estimate the number of nodes needed to support the predicted load. The number of nodes selected to be simultaneously upgraded or the number of nodes to quickly revert into the active cluster of nodes is estimated based on the output of the capacity planner.

The load predictor and the capacity planner determine the minimum number of nodes needed to support the load and to meet the desired performance parameters during the upgrade period. If the sum of the number of nodes required to support load and performance and the number of nodes selected for upgrading exceeds the current total number of active nodes, additional nodes are dynamically added to the cluster of active nodes to continue to meet the load and performance parameters. Once additional nodes are selected, the process of quiescing the selected subset of nodes and upgrading these nodes proceeds as before. The desired upgrade is propagated through all affected nodes while maintaining this elevated level of nodes in the active cluster of nodes. After the upgrade process is complete, the additionally provisioned nodes are returned to a free pool of available system resources. Additional, unexpected load peaks during the upgrade are handled as described above by reverting one or more nodes back into the active cluster of nodes.

### BRIEF DESCRIPTION OF THE DRAWINGS

FIG. 1 is a schematic representation of a computer network system for use in accordance with exemplary embodiments of the present invention;

FIG. 2 is a flow chart illustrating an embodiment of a method for maintaining nodes in a computer network in accordance with exemplary embodiments of the present invention;

FIG. 3 is a flow chart illustrating an embodiment of selecting a subset of nodes to receive a predefined maintenance;

FIG. 4 is a flow chart illustrating an embodiment of performing the predefined maintenance; and

FIG. 5 is a flow chart illustrating an embodiment of validating the maintenance.

### DETAILED DESCRIPTION

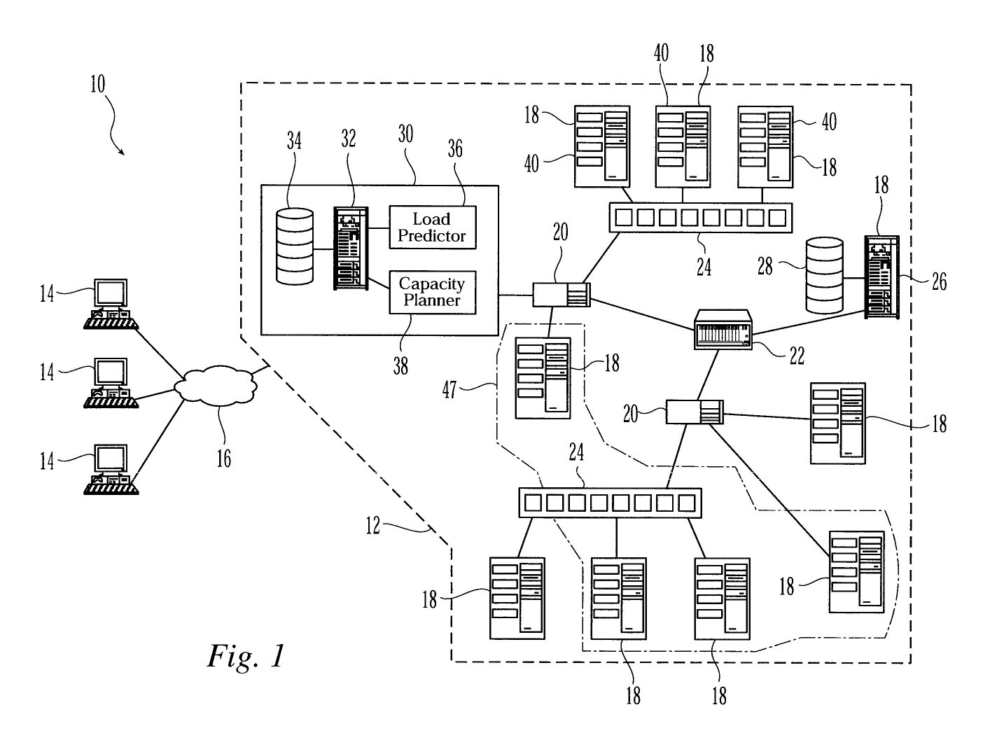

Referring initially to FIG. 1, an exemplary system environment 10 in accordance with the present invention is illustrated. The system 10 includes at least one computer network 12 arranged to provide one or more services or applications to a plurality of users 14. These services or applications include high volume applications such as high volume web sites. Typically, the users 14 are in communication with the computer network 12 across one or more networks 16. Suitable networks 16 include, but are not limited to, wide area networks (WAN), such as the internet or World Wide Web, and local area networks (LAN). Suitable computer networks 12 can be arranged as clustered computer systems and grid computer systems.

The computer network 12 includes a variety of components to provide the desired services and applications to the users 14. As illustrated, these components include, but are not limited to, a plurality of servers 18, routers 20, switches 22 and hubs 24. The computer network 12 can be arranged as a distributed network of independent computers, such as personal computers, or as one or more arrangements of client/server systems. Each one of the components in the computer network includes software applications that provide for the operation of the device itself, the operation of the computer network itself including routing functions, and the provision of services to the users of the computer network. The components in the computer network 12 define a plurality of nodes. As used herein, each node can refer to one of the physical components in the computer network or can refer to an environment on which an application server runs. In an embodiment where a node is an environment on which an application server runs, each application server hosts one or more software applications, and each physical component within the computer network can contain more than one node.

The components within the computer network 12 also contain one or more data servers 26 in communication with one or more databases 28. The data servers 26 provide storage and delivery of data to support applications and operation of the various components. The data servers 26 also store historical data and data about the configuration of the computer network and provide system redundancy.

In one embodiment, the computer network 12 includes a routing mechanism 30 that receives and processes requests from the users 14 to execute applications hosted by the system 12, for example applications provided by one or more of the servers 18. In one embodiment, the routing mechanism is an on-demand router, and the servers 18 are contained in a web or application tier and arranged in one or more server clusters. The data server can be arranged in a data tier that can contain additional data servers, and one or more of the nodes within the system can be arranged in a free pool of nodes 40 to provide additional available capacity to the system.

The network routing mechanism 30 distributes work requests across the various nodes in accordance with prescribed performance parameters that are specified, for example, in service level objectives (SLO's), service level agreements (SLA's) and combinations thereof. In order to facilitate work distribution, the network routing mechanism contains a processor, for example a computer, server or programmable logic controller, in communication with a database 34 that can be used to contain data necessary to facilitate proper work distribution. The network routing mechanism 30 incorporates a load predictor 36 and a capacity planner 38 that are used to determine the number and identity of nodes required to achieve the prescribed performance parameters. The network routing mechanism 30 monitors workload and records a history of the performance parameters, for example on the database 34, to facilitate workload balancing decisions.

The network routing mechanism 30 delivers work or requests to nodes within the system that are active members of the server cluster. In one embodiment, when the performance parameters cannot be achieved with the currently active set of nodes, an administrative agent within the routing mechanism 30 is activated to orchestrate a provisioning action. Using the load predictor 36 and capacity planner 38, the administrative agent determines the optimal number of nodes required to achieve the performance parameters and triggers a provisioning agent to allocate additional nodes from the free pool 40 as required. In alternative embodiments, the nodes can be divided into tiers, and the services can be divided across the tiers, for example separating web and application serving tiers across distinct nodes. Additionally, an application in one server cluster may call other applications in other server clusters. Each such application-to-application interaction typically passes through another network routing mechanism tier.

These various components within a computer network require periodic maintenance. Maintenance includes activities performed on the components to maintain or restore the desired serviceability of the computer network. Suitable maintenance includes, but is not limited to, installing software application upgrades, installing software application fixes or patches, installing new software applications, updating computer virus definitions and combinations thereof. Methods in accordance with exemplary embodiments of the present invention enable dynamic application updates to the components in the computer system while maintaining and meeting the prescribed performance parameters in the computer network. In one embodiment, the administrative agent within the network routing mechanism coordinates the routing of requests and the performance of the desired maintenance to meet the desired performance parameters continuously during performance of the maintenance. For example, the administrative agent prevents requests from flowing to a node undergoing maintenance and thereby being lost, monitors the workload during maintenance, and adjusts the active pool of nodes in response to performance parameter requirements.

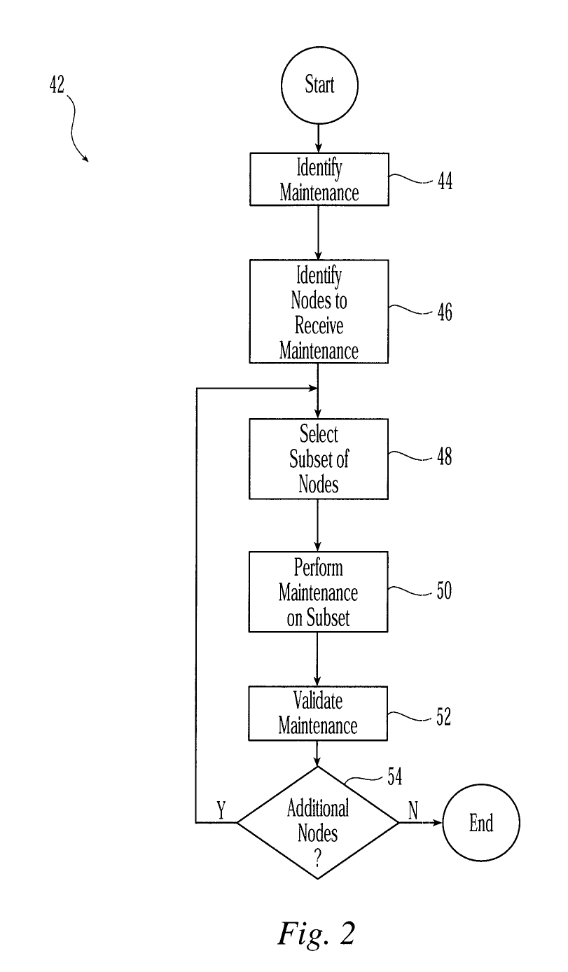

Referring to FIG. 2, an embodiment of a method for maintaining a computer network 42 in accordance with exemplary embodiments of the present invention is illustrated. Initially, the maintenance to be performed on the computer network, and in particular on one or more components within the computer network is identified 44. This predefined maintenance may not be required in all of the nodes or components contained in the computer network. For example, an upgrade to a particular software application is only required in nodes that are running that software application and that have not previously received the predefined maintenance. Therefore, a plurality of nodes in the computer network that are to receive the predefined maintenance are identified 46. As illustrated in FIG. 1, the identified nodes 47 can include one or more components, for example servers, within the computer network. Although illustrated as containing entire servers, the identified nodes 47 can contain only portions of servers or other components since any given component can represent more than one node. In addition, only portions of the nodes that are relevant to the predefined maintenance are identified. Suitable methods for identifying relevant portions of nodes are described in pending U.S. patent application Ser. No. 09/675,790, which is incorporated herein by reference in its entirety.

In one embodiment, identification of the nodes affected by the predefined maintenance is accomplished automatically by maintaining data on the structure and contents of the computer network in, for example, the data server 26. Alternatively, identification of the affected nodes is accomplished manually, for example as a user-defined input.

Having identified the nodes requiring the predefined maintenance, a subset of the identified nodes is selected 48 such that the subset contains the maximum number of nodes that can simultaneously receive the predefined maintenance without significantly inhibiting prescribed performance parameters in the computer network. The number of nodes selected will vary depending upon current and anticipated loads to the computer system. In one embodiment, the current load level requires all available nodes to meet the performance parameters, and no nodes are selected. In one embodiment, the upgrade process is deferred and retried at a later time when the load on the cluster allows a subset of the nodes to be identified and processed for upgrade. Alternatively, the number of nodes selected can vary from a single node up to all of the nodes that were identified as requiring the predefined maintenance.

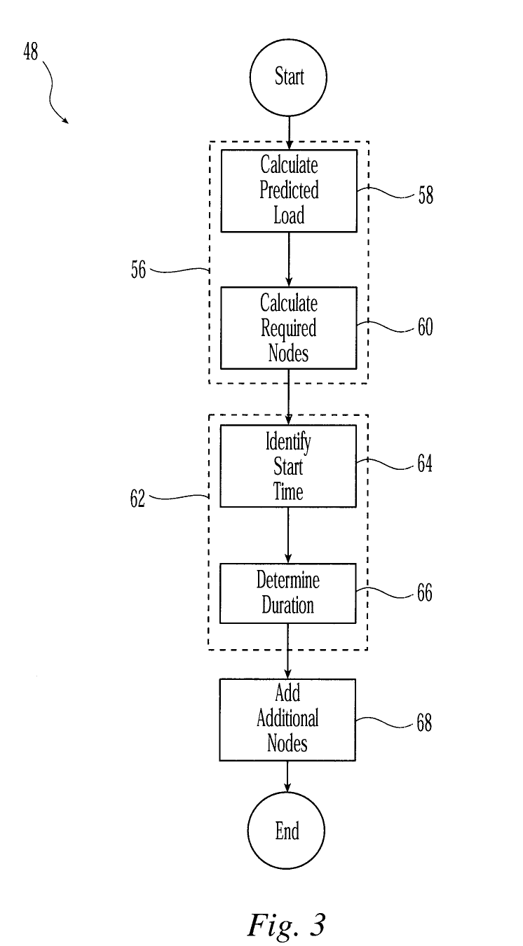

Referring to FIG. 3, and embodiment for selecting the subset of nodes 48, or for selecting only the relevant portion of a subset of nodes, is illustrated. Initially, the maximum number of nodes that can simultaneously receive the predefined maintenance while still achieving the prescribed performance parameters with a remaining set of nodes from the identified nodes is determined 56. In one embodiment, historical load data and current load data are used to determine a predicted load 58. This predicted load is then used to estimate the remaining set of nodes required to support the predicted load 60. The remaining nodes refer to the nodes remaining active in the computer network during the maintenance of the selected nodes. The availability of these remaining nodes can be calculated by subtracting the nodes in the selected subset from either the identified nodes or from all nodes in the computer network. If the calculation of the availability of remaining nodes indicates that insufficient nodes are available, then additional nodes can be added to the computer network to create the estimated remaining set of nodes required 68.

Since the loads vary with time and varying loads require varying numbers of nodes, a period of time over which the remaining set can achieve the prescribed performance parameters is identified 62. In one embodiment, historical load data are used to determine the length of time that a particular load is expected in the system. Preferably, the identified period of time is approximately an average time required to perform the predefined maintenance in one node. Therefore, a load is predicted for the period of time that the predefined maintenance is performed on the selected subset of nodes. In addition to the duration of time for which the predicted load is expected, a start time for the duration is identified 64. Maintenance is initiated at the identified start time.

Referring again to FIG. 2, having selected the subset of nodes to receive the predefined maintenance, maintenance is performed on the nodes in the selected subset 50. Since the selected subset can contain less then all of the identified nodes requiring the predefined maintenance, subset selection and maintenance are performed iteratively until all of the identified nodes have received the predefined maintenance. In one embodiment, a check is made to determine if additional nodes exist in the identified nodes that have not received the maintenance 54. If all nodes have received the predefined maintenance, the process is completed. If additional nodes exist, the process is repeated by picking another subset of nodes, or subset of relevant node portions, up to the number of nodes remaining to receive the predefined maintenance, and maintenance is performed on the next selected subset as before.

In one embodiment, the success of the maintenance is validated in the nodes 52 after completion of the maintenance on each selected subset. Maintenance continues upon a positive validation until all identified nodes have received the predefined maintenance. If the validation fails, all nodes are returned to a pre-maintenance state, and the process is halted. Error messages can be provided to indicate that the maintenance did not validate and to provide details on the reason for validation failure.

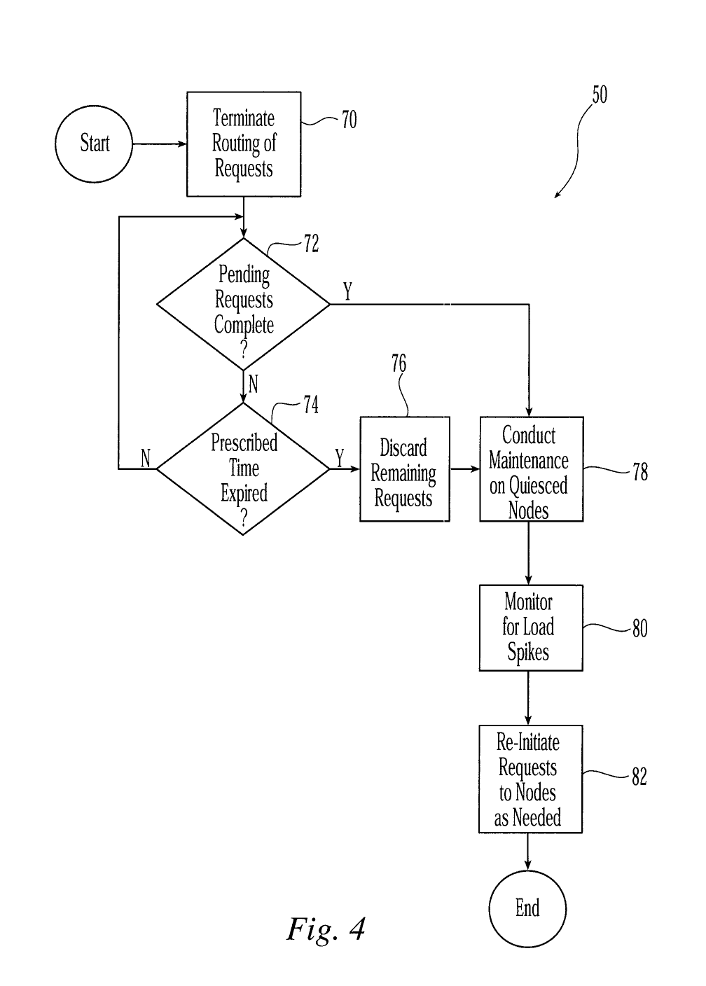

Referring to FIG. 4, in one embodiment, performing the predefined maintenance on the selected subset involves removing the selected nodes as active nodes in the computer network, i.e. causing these nodes to quiesce. In order to remove the selected nodes, the routing of new requests to the selected subset of nodes is terminated 70, for example at the identified start time for the maintenance. Although no new requests are being sent to the selected nodes, one or more of the selected nodes may be handling existing requests. Therefore, the selected subset of nodes is monitored for completion of all pending requests 72. The predefined maintenance is performed upon detection of the completion of all pending requests 78.

In one embodiment, a prescribed time limitation is placed on the completion of pending requests. Therefore, as long as it is determined that all pending requests have not been completed, a check is made to determine if the prescribed time limit has expired 74. If the prescribed time limit expires before all of the pending requests have been completed, then the remaining uncompleted requests are discarded 76, and the predefined maintenance is performed 78.

Although a predicted load has been calculated for the time period that maintenance is being performed on the selected subset of nodes, unanticipated load spikes can occur, and the number of active nodes may be inadequate to handle these unexpected load spikes. In one embodiment, the computer network is monitored during maintenance of the selected subset for any unanticipated load spikes 80. Should a load spike occur, one or more of the selected nodes is returned to the active cluster of nodes by, for example, re-initiating requests to these nodes 82. In one embodiment, the termination of routing of new requests to the subset of nodes is staggered or performed sequentially so that the predefined maintenance is performed on only a portion of the subset of nodes at any given time. This ensures that nodes exist in the subset of selected nodes that can be quickly returned to the active cluster of nodes in response to a load spike.

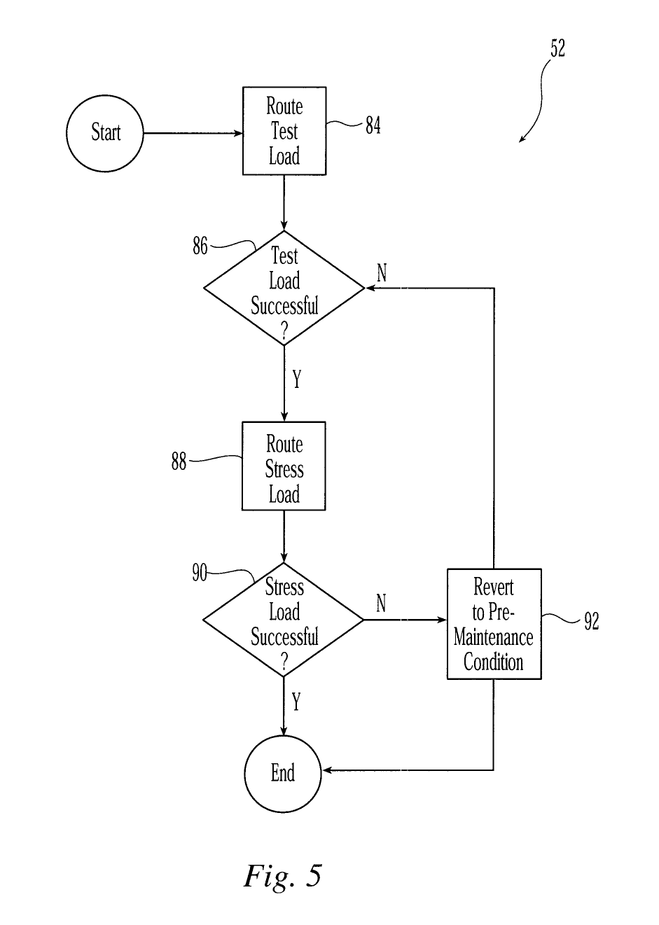

Referring to FIG. 5, an embodiment for validating the maintenance in the selected subset of nodes 52 is illustrated. Initially, a test load is routed to all nodes in the selected set of nodes 84. If the test load is successful 86, then a stress load is routed all nodes in the selected subset of nodes 88. If the stress load is successful 90, then the validation is successful. If the test load or stress load fail, then the nodes in the selected subset of nodes are reverted to a state before they received the predefined maintenance 92, and further maintenance is halted. Although illustrated sequentially as a test load followed by a stress load, validation of the maintenance can involve either the test load alone or the stress load alone.

The present invention is also directed to a computer readable medium containing a computer executable code that when read by a computer causes the computer to perform a method for maintaining components and nodes within a computer network while handling loads in the computer network and meeting prescribed performance parameters in accordance with exemplary embodiments of the present invention and to the computer executable code itself. The computer executable code can be stored on any suitable storage medium or database, including databases disposed within, in communication with and accessible by the computer network and can be executed on any suitable hardware platform as are known and available in the art.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s). Therefore, it will be understood that the appended claims are intended to cover all such modifications and embodiments, which would come within the spirit and scope of the present invention.

What is claimed is:

1. A method for maintaining a computer network, the method comprising:
identifying a plurality of nodes in the computer network to receive a predefined maintenance;
selecting a subset of the identified nodes, the subset comprising a maximum number of nodes capable of simultaneously receiving the predefined maintenance without significantly inhibiting prescribed performance parameters in the computer network;
performing the predefined maintenance on the nodes in the selected subset; and
repeating the selection of subsets of the identified nodes until all identified nodes receive the predefined maintenance.

2. The method of claim 1, wherein the predefined maintenance comprises installing software application upgrades, installing software application patches, installing new software applications, updating computer virus definitions or combinations thereof.

3. The method of claim 1, wherein the performance parameters comprise service level agreements, service level objectives or combinations thereof.

4. The method of claim 1, wherein the step of selecting the subset comprises:
determining if the maximum number of nodes that can simultaneously receive the predefined maintenance while still achieving the prescribed performance parameters with a remaining set of nodes from the identified nodes; and
identifying a period of time over which the remaining set can achieve the prescribed performance parameters.

5. The method of claim 4, wherein the step of identifying the period of time comprises approximating an average time required to perform the predefined maintenance in one node.

6. The method of claim 4, wherein the step of determining the maximum number of nodes comprises using historical load data and current load data to determine a predicted load; and
estimating the remaining set of nodes required to support the predicted load.

7. The method of claim 6, further comprising adding additional nodes to the computer network to create the estimated remaining set of nodes.

8. The method of claim 4, wherein the step of selecting the subset further comprises:
determining a start time for the period of time; and
initiating the predefined maintenance at the start time.

9. The method of claim 1, wherein the step of performing the predefined maintenance comprises:
terminating the routing of new requests to the selected subset of nodes;
monitoring the selected subset of nodes for completion of all pending requests in the subset of nodes; and
performing the predefined maintenance upon detection of the completion of all pending requests.

10. The method of claim 9, further comprises discarding all pending uncompleted requests in the subset of nodes upon expiration of a prescribed period of time.

11. The method of claim 9, wherein the step of terminating the routing of new requests comprises terminating the routing of new requests to the subset of nodes sequentially so that the predefined maintenance is performed on only a portion of the subset of nodes at any given time.

12. The method of claim 9, further comprising:
monitoring for load spikes during maintenance of the selected subset; and
re-initiating requests to one or more nodes in the selected subset of nodes to support any detected load spikes.

13. The method of claim 1, further comprising validating the selected subset of nodes after completion of the predefined maintenance.

14. The method of claim 13, wherein the step of validating the maintenance comprises:
routing a test load to the selected nodes; and
reverting the selecting nodes back to a pre-maintenance state upon failure of the selected nodes to handle the test load.

15. The method of claim 13, wherein the step of validating the maintenance comprises:
routing a stress load to the selected nodes; and
reverting the selecting nodes back to a pre-maintenance state upon failure of the selected nodes to handle the stress load.

16. A computer readable medium containing a computer executable code that when read by a computer causes the computer to perform a method for maintaining a computer network, the method comprising:
identifying a plurality of nodes in the computer network to receive a predefined maintenance;
selecting a subset of the identified nodes, the subset comprising a maximum number of nodes capable of simultaneously receiving the predefined maintenance without significantly inhibiting prescribed performance parameters in the computer network;
performing the predefined maintenance on the nodes in the selected subset; and
repeating the selection of subsets of the identified nodes until all identified nodes receive the predefined maintenance.

17. The computer readable code of claim 16, wherein the predefined maintenance comprises installing software application upgrades, installing software application patches, installing new software applications, updating computer virus definitions or combinations thereof.

18. The computer readable code of claim 16, wherein the performance parameters comprise service level agreements, service level objectives or combinations thereof.

19. The computer readable code of claim 16, wherein the step of selecting the subset comprises:
determining if the maximum number of nodes that can simultaneously receive the predefined maintenance while still achieving the prescribed performance parameters with a remaining set of nodes from the identified nodes; and
identifying a period of time over which the remaining set can achieve the prescribed performance parameters.

20. The computer readable code of claim 19, wherein the step of identifying the period of time comprises approximating an average time required to perform the predefined maintenance in one node.

21. The computer readable code of claim 19, wherein the step of determining the maximum number of nodes comprises using historical load data and current load data to determine a predicted load; and
estimating the remaining set of nodes required to support the predicted load.

22. The computer readable code of claim 21, further comprising adding additional nodes to the computer network to create the estimated remaining set of nodes.

23. The computer readable code of claim 19, wherein the step of selecting the subset further comprises:
determining a start time for the period of time; and
initiating the predefined maintenance at the start time.

24. The computer readable code of claim 16, wherein the step of performing the predefined maintenance comprises:
terminating the routing of new requests to the selected subset of nodes;
monitoring the selected subset of nodes for completion of all pending requests in the subset of nodes; and
performing the predefined maintenance upon detection of the completion of all pending requests.

25. The computer readable code of claim 24, further comprises discarding all pending uncompleted requests in the subset of nodes upon expiration of a prescribed period of time.

26. The computer readable code of claim 24, wherein the step of terminating the routing of new requests comprises terminating the routing of new requests to the subset of nodes sequentially so that the predefined maintenance is performed on only a portion of the subset of nodes at any given time.

27. The computer readable code of claim 24, further comprising:
monitoring for load spikes during maintenance of the selected subset; and
re-initiating requests to one or more nodes in the selected subset of nodes to support any detected load spikes.

28. The computer readable code of claim 16, further comprising validating the selected subset of nodes after completion of the predefined maintenance.

29. The computer readable code of claim 28, wherein the step of validating the maintenance comprises:
routing a test load to the selected nodes; and
reverting the selecting nodes back to a pre-maintenance state upon failure of the selected nodes to handle the test load.

30. The computer readable code of claim 28, wherein the step of validating the maintenance comprises:
routing a stress load to the selected nodes; and
reverting the selecting nodes back to a pre-maintenance state upon failure of the selected nodes to handle the stress load.
